(19) United States
(12) Patent Application Publication
(10) Pub. No.: US 2005/0135359 A1
(43) Pub. Date: Jun. 23, 2005

(54) System and method for IPSEC-compliant network address port translation

(76) Inventor: Chun-Ping Chang, TaiPing City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/855,083

(22) Filed: May 27, 2004

(30) Foreign Application Priority Data
Dec. 19, 2003 (TW) 92136132

(51) Int. Cl. H04L 12/28

(52) U.S. Cl. 370/389; 370/392; 713/160

(57) ABSTRACT

A system for IPsec-compliant network address port translation. The system comprises a communication unit, a storage device, and a processor. The communication unit receives an outgoing first Internet Key Exchange (IKE) packet and a first incoming Encapsulating Security Payload (ESP) packet. The IKE packet comprises an IP header specifying a private source IP address and a first destination IP address. The ESP packet comprises a first source IP address and a second destination IP address, wherein the first source IP address equals the first destination IP address. The storage device stores the private source IP address and the first destination IP address in corresponding fields of a first table. The processor, connected to the communication unit and the storage device, retrieves the first source IP address of the first ESP packet, searches the first table for a match of the first source IP address, and substitutes the searched match for the second destination IP address of the ESP packet.

### BACKGROUND OF THE INVENTION

1. Field of the Invention

The present invention relates to network communication and particularly to a system and method for IPsec-compliant network address port translation capable of processing IPsec packets.

2. Description of the Related Art

IPsec, short for Internet Protocol Security, provides a set of protocols developed by the Internet Engineering Task Force (IETF) to support secure exchange of packets at the IP layer. IPsec is said to be especially useful for implementing virtual private networks and for remote user access through dial-up connection to private networks. IPsec employs two kinds of packets: Internet Key Exchange (IKE) packets and Encapsulating Security Payload (ESP) packets.

One major issue with deploying Internet Protocol security (IPSec) is that IPSec peers cannot be located behind a Network Address Port Translation (NAPT) device. Internet service providers and small office/home office (SOHO) networks commonly use NAPTs to share a single public IP address. Although NAPTs help conserve remaining IP address space, they also introduce problems for end-to-end protocols such as IPSec.

Conventionally, there are problems associated with processing packets using NAPTs.

For IKE packets, some implementations of IPSec use UDP port 500 as both the source and destination UDP port numbers. However, for an IPSec peer located behind a NAPT, the NAPT changes the source IP address of the initial IKE Main Mode packet. Depending on the implementation, IKE traffic from a port other than 500 may be discarded.

For ESP packets, ESP-protected IPSec traffic does not contain a visible IP header. The ESP header is between the outer IP header and the encrypted original IP header and uses an IP protocol of 50. Because of this, NAPT can't make use of TCP or UDP port numbers to multiplex traffic to different private network hosts. The ESP header contains a field entitiled Security Parameters Index (SPI). The SPI, in conjunction with the destination IP address in the plaintext IP header and the IPSec security protocol (ESP or AH), identifies an IPSec security association (SA). For inbound traffic to the NAPT, the destination IP address must be mapped to a private IP address. For multiple IPSec peers on the private side of a NAPT, the destination IP addresses of inbound traffic for multiple IPSec ESP data streams are the same. To distinguish one IPSec ESP data stream from another, the destination IP address and SPI must either be tracked or mapped to a private destination IP address and SPI. Because the SPI is a 32-bit number, the chance of using the same SPI value between multiple private network clients is low. The problem is that it is difficult to determine which outbound SPI value corresponds to which inbound SPI value. NAPTs cannot map the SPI, because the ESP trailer contains a hashed message authentication code (HMAC) that verifies the integrity of the ESP protocol data unit (PDU) (consisting of the ESP header, the ESP payload, and the ESP trailer), such that the SPI cannot be changed without invalidating the HMAC value.

Hence, there is a need for a network address port translation system that addresses the problems arising from the existing technology.

### SUMMARY OF THE INVENTION

It is therefore an object of the invention to provide a system and method for network address port translation to use IPsec over NAPTs. To achieve this and other objects, the present invention provides a system and method for IPsec-compliant network address port translation capable of processing IKE and ESP packets through NAPT devices.

According to the invention, a method for network address port translation is provided within a gateway device. First, an outgoing first Internet Key Exchange (IKE) packet is provided. The first IKE packet comprises an IP header specifying a private source IP address and a first destination IP address. The first destination IP address is directed to a node outside the VPN. Second, the private source IP address and the first destination IP address are stored in corresponding fields in a first table. A first incoming Encapsulating Security Payload (ESP) packet is then received. The ESP packet comprises a first source IP address and a second destination IP address, wherein the first source IP address equals the first destination IP address. The first source IP address of the first ESP packet is then retrieved. The first table is searched to find a match of the first source IP address. The located match is then substituted for the second destination IP address of the ESP packet.

The invention also provides a system for IPsec-compliant network address port translation. The system comprises a communication unit, a storage device, and a processor. The communication unit receives a first Internet Key Exchange (IKE) packet and a first incoming Encapsulating Security Payload (ESP) packet. The first IKE packet comprises an IP header specifying a private source IP address and a first destination IP address. The first ESP packet comprises a first source IP address and a second destination IP address, wherein the first source IP address equals the first destination IP address. The storage device stores the private source IP address and the first destination IP address in corresponding fields in a first table. The processor, connected to the communication unit and the storage device, retrieves the first source IP address from the first ESP packet, searches the first table for a match of the first source IP address, and substitutes the match for the second destination IP address of the first ESP packet.

The above-mentioned method may take the form of program code embodied in a computer readable tangible media. When the program code is loaded into and executed by a machine, the machine becomes an apparatus for practicing the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a network system according to the present invention;

FIG. 2 is a block diagram of a NAPT device according to the present invention;

FIGS. 3A and 3B are flowcharts of a NAPT method for an IPsec packet according to the present invention; and

FIG. 4 is a diagram of a storage medium storing a computer program providing the network address port translation method of the present invention.

### DETAILED DESCRIPTION

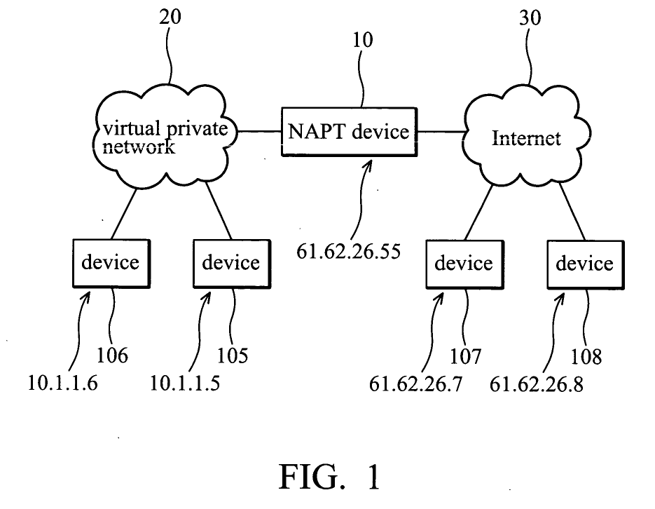

The present invention will now be described with reference to FIGS. 1 to 4, which in general relate to a system for network address port translation.

FIG. 1 is a schematic view of a network system according to the present invention. Using FIG. 1 as an example, a network system comprises an Internet 30, a NAPT device 10, and a virtual private network 20. The NAPT device 10 is connected to the virtual private network 20 and the Internet 30. The NAPT device 10 is assigned a public address “61.62.26.55”. Each device in the virtual private network 20 is assigned a private IP address. For example, devices 105 and 106, located in the virtual private network 20, are assigned private IP addresses of “10.1.1.5” and “10.1.1.6”, respectively. Devices 107 and 108 connect to the NAPT via the Internet 30, wherein the devices 107 and 108 are assigned public IP addresses as “61.62.26.7” and “61.62.26.8”, respectively. According to the embodiment, the devices 105 and 106 are initiators for IPsec traffic, and devices 107 and 108 are receivers.

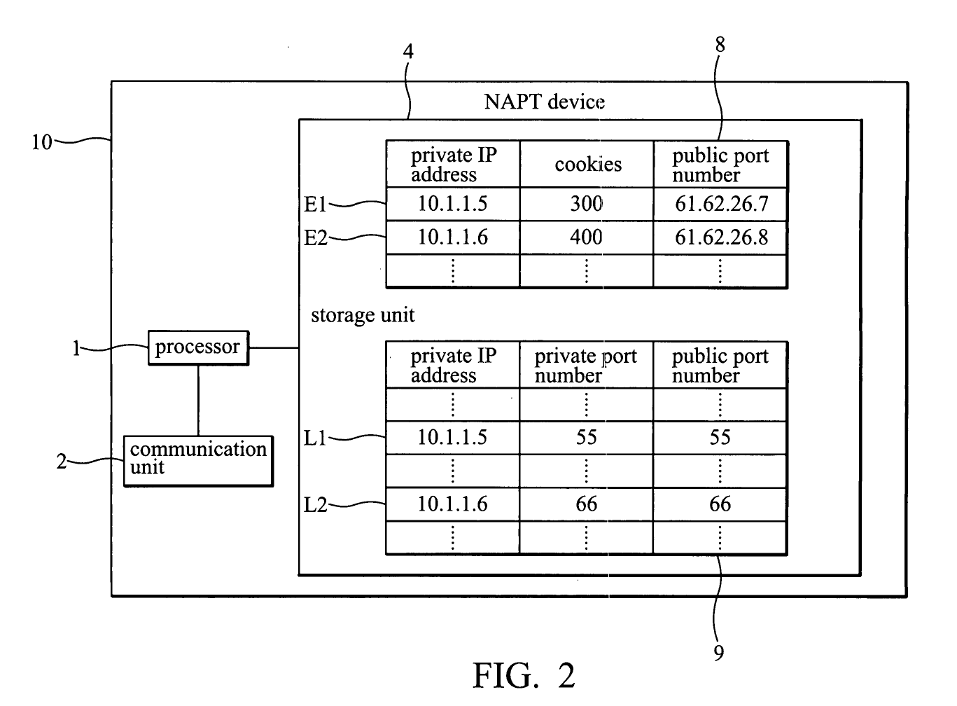

Referring to FIG. 2, the NAPT device 10 comprises a processor 1, a communication unit 2, and a storage unit 4. The processor 1 is connected to the storage unit 4 and the communication unit 2. The communication unit 2 receives and transmits packets. The storage unit 4 stores an address table 8 and a NAPT table 9. The address table 8 comprises fields for private IP address, cookie values, and public IP addresses. The NAPT table 9 comprises fields for private IP addresses, private port numbers, and public port numbers. The NAPT table 9 specifies correspondence among private IP address, private port number, and public port number of a packet.

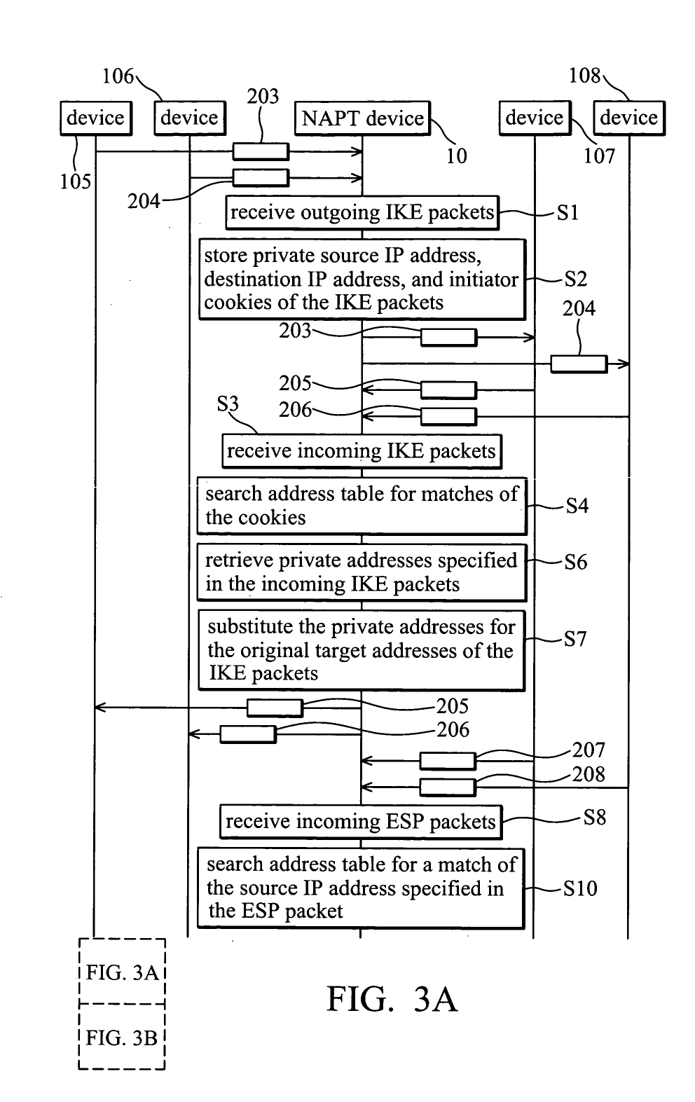

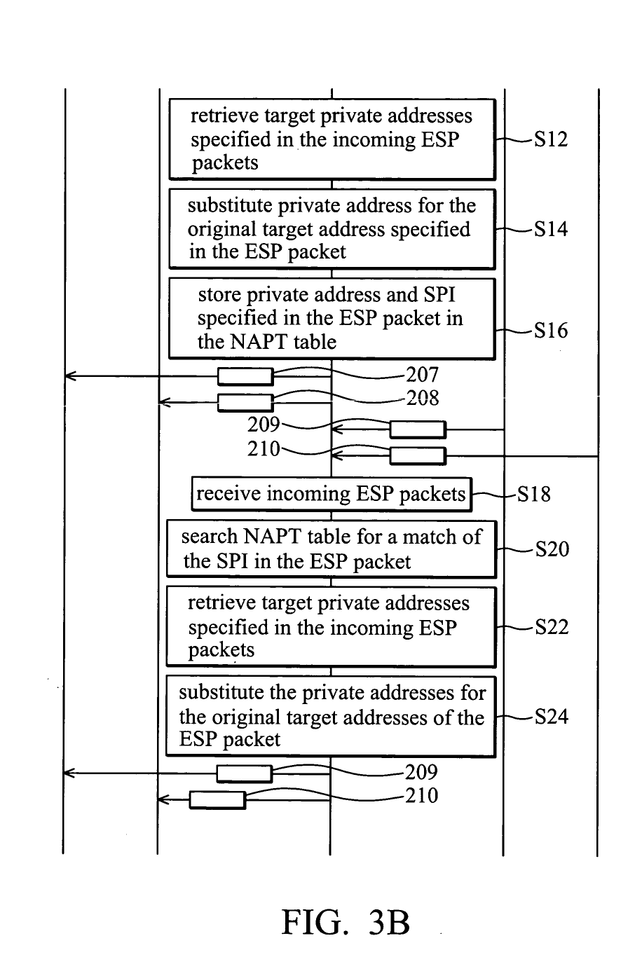

FIGS. 3A and 3B are flowcharts of a NAPT method processing IPsec packets according to the present invention.

First, outgoing IKE packets 203 and 204 are transmitted from devices 105 and 106 to devices 107 and 108, and the IKE packets 203 and 204 are then received by NAPT device 10 (step S1). The IKE packets 203 and 204 are then transferred from the communication unit 2 to the processor 1, and private source IP address, destination IP address, and initiator cookies of the IKE packets 203 and 204 are stored in rows E1 and E2 of the address table 8, respectively (step S2). The source IP addresses for the IKE packets 203 and 204 are “10.1.1.5” and “10.1.1.6”, and stored in fields for private address. The cookies are “300” and “400”, and stored in fields for cookies. The destination IP addresses are “61.62.26.7” and “61.62.26.8”, and stored in fields for public address.

The IKE packets 203 and 204 are then transmitted to devices 107 and 108 by the processor 1 via the communication unit 2.

IKE packets 205 and 206 are then sent from the devices 107 and 108 to the devices 105 and 106. The IKE packets 205 and 206 are then received by NAPT device 10 (step S3), and relayed from the communication unit 2 to the processor 1. The IKE packets 205 and 206 comprise the same destination IP address “61.62.26.55”, the public address of the NAPT device 10. The initiator cookies for IKE packets 205 and 206 are “300” and “400”, and the source IP addresses are “61.62.26.7” and “61.62.26.8”, respectively.

The address table 8 is then searched for matches of the cookies of the IKE packets 205 and 206 (step S4). The aforementioned matches are found in rows E1 and E2 of the address table 8. Private addresses stored in rows E1 and E2 are retrieved (step S6) and substituted for the original target addresses of the IKE packets 205 and 206, respectively (step S7). After the target addresses are changed, IKE packets 205 and 206 are transmitted to devices 105 and 106, respectively.

When IKE negotiation is finished and an IPsec connection is established, IPsec traffic is processed using ESP packets. According to the embodiment, ESP packets are transmitted through ESP tunnel mode. The header of the ESP packet can be read by NAPT device 10 in the ESP tunnel mode. The ESP header comprises a Security Parameters Index (SPI) and a sequence. Different nodes for IPsec connection correspond to different SPIs. ESP packets from the same source have the same SPI. After the ESP packet is received by the NAPT device 10, the source IP address specified in the outer IP header of the ESP packet is substituted by the public address thereof. The ESP packet is then transmitted to its target via the Internet 30.

Incoming ESP packets 207 and 208 are sent from the devices 107 and 108 to the NAPT device 10, wherein the ESP packets 207 and 208 have the same target address “61.62.26.55”, the public address of the NAPT device 10. The target addresses of the ESP packets 207 and 208 must be translated to private addresses of the target devices located within the virtual private network 20. An IPSec connection is first established using IKE packets and then information is transmitted using ESP packets. The private addresses of the targets for ESP packets 207 and 208 are determined according to the correspondence between the receiver public address and the initiator private source IP address according to the address table 8.

The incoming ESP packet 207 is then relayed from the communication unit 2 to the processor 1 (step S8). The address table 8 is then searched for a match of the source IP address, “61.62.26.7”, specified in the outer IP header of the ESP packet 207 (step S10). The match is found in row E1, and the value stored in the private address field of row E1 is retrieved, “10.1.1.5” (step S12). The private address “10.1.1.5” is substituted for the original target address specified in the outer IP header of the ESP packet 207 (step S14). The private address and the SPI specified in the ESP packet 207 is then stored in the NAPT table 9 (step S16). According to the embodiment, the located private address is stored in the private address field in the row L1 of the NAPT table 9, and the SPI is split into two parts and stored in fields for private and public port numbers. The ESP packet 207 is then transmitted to device 105 by the communication unit 2 according to the substituted target address.

Similarly, the incoming ESP packet 208 is then relayed from the communication unit 2 to the processor 1. The address table 8 is then searched for a match of the source IP address, “61.62.26.8”, specified in the outer IP header of the ESP packet 208. The match is found in row E2, and the value stored in the private address field of row E2 is retrieved, “10.1.1.6”. The private address “10.1.1.6” is substituted for the original target address specified in the outer IP header of the ESP packet 208. The private address and the SPI specified in the ESP packet 208 is then stored in the NAPT table 9. According to the embodiment, the located private address is stored in the private address field in the row L2 of the NAPT table 9, and the SPI is split into two parts and stored in fields for private and public port numbers. The ESP packet 208 is then transmitted to device 106 by the communication unit 2 according to the substituted target address.

When a new incoming ESP packet 209 is transmitted from device 107 to the NAPT device 10 (step S18), the address table 8 is skipped, and the NAPT table 9 is searched for a match of a SPI specified in the ESP packet 209 (step S20). The match is found in row L1, and the value stored in the private address field of row L1 is retrieved, “10.1.1.5” (step S22). The private address “10.1.1.5” is substituted for the original target address specified in the outer IP header of the ESP packet 209 (step S24). The ESP packet 209 is then transmitted to device 105 by the communication unit 2 according to the substituted target address.

Similarly, when a new incoming ESP packet 210 is transmitted from device 108 to the NAPT device 10, the address table 8 is skipped, and the NAPT table 9 is searched for a match of a SPI specified in the ESP packet 210. The match is found in row L2, and the value stored in the private address field of row L2 is retrieved, “10.1.1.6”. The private address “10.1.1.6” is substituted for the original target address specified in the outer IP header of the ESP packet 210. The ESP packet 210 is then transmitted to device 106 by the communication unit 2 according to the substituted target address.

Target information stored in an outgoing IKE packet, such as a destination IP address and cookie, can specify the correspondence between a private address and a public address or target cookies.

The method for network address port translation implemented in the system for network address port translation of the present invention, or certain aspects or portions thereof, may take the form of program code (i.e. instructions) embodied in a tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

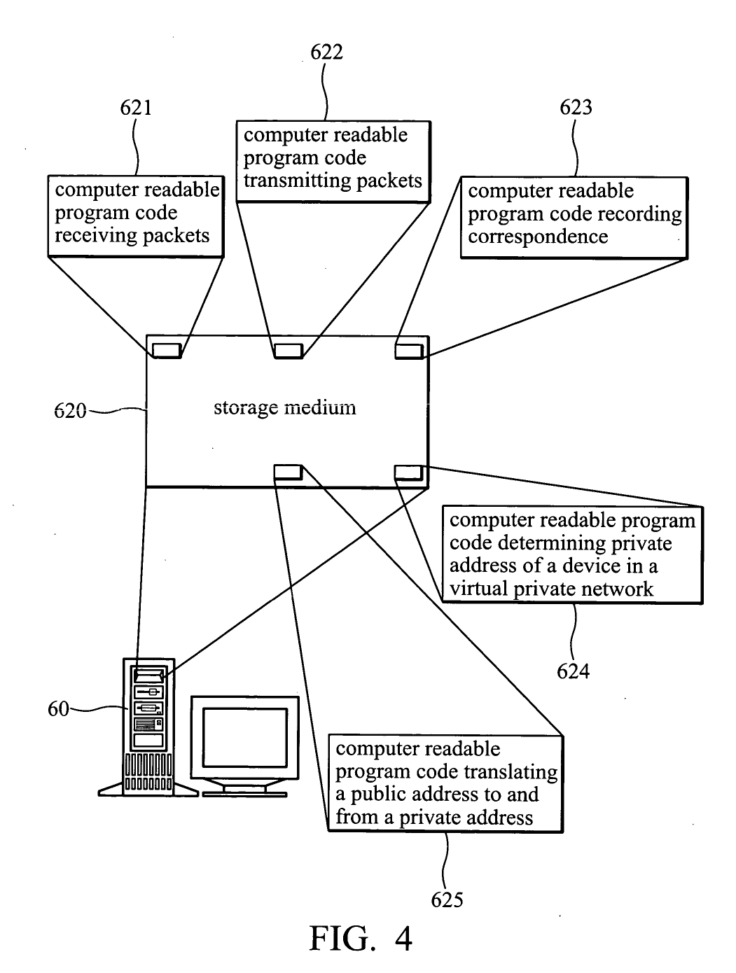

FIG. 4 is a schematic diagram of a storage medium for a computer program providing the method for network address port translation according to the present invention. The computer program product includes a storage medium 620 having computer readable program code embodied in the medium for use in a computer system 60, the computer readable program code comprising at least computer readable program code 621 receiving outgoing and incoming packets, computer readable program code 622 transmitting packets, computer readable program code 623 recording correspondence between the private IP address, source cookies, destination IP address and SPI, computer readable program code 624 determining private address of a device in a virtual private network, and computer readable program code 625 translating a public address to and from a private address.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for IP security protocol (IPsec)-compliant network address port translation (NAPT), implemented in a gateway of a virtual private network (VPN), comprising:
providing an outgoing first Internet Key Exchange (IKE) packet, comprising an IP header specifying a private source IP address and a first destination IP address, wherein the first destination IP address is directed to a node outside the VPN;
recording the private source IP address and the first destination IP address in corresponding fields of a first table;
receiving a first incoming Encapsulating Security Payload (ESP) packet, comprising a first source IP address and a second destination IP address, wherein the first source IP address equals the first destination IP address;
retrieving the first source IP address of the first ESP packet;
searching the first table for a match of the first source IP address; and
substituting the match for the second destination IP address of the ESP packet.

2. The method of claim 1, further comprising:
retrieving a first SPI of the first ESP packet;
recording the first SPI and the private source IP address in corresponding fields of a second table;
receiving a second incoming ESP packet, comprising a third destination IP address and a second SPI, wherein the second SPI equals the first SPI;
retrieving the second SPI of the second ESP packet; and
substituting the private source IP address for the third destination IP address of the ESP packet according to the first and second tables.

3. The method of claim 2, wherein the SPI is stored in preset fields for private and public port numbers of a network address port translation table.

4. The method of claim 1, further comprising:
retrieving a first source cookie of the first IKE packet;
recording correspondence between the first source cookie and the private source IP address of the first IKE packet;
receiving an incoming second IKE packet comprising a second source cookie equaling the first source cookie; and
substituting the private source IP address for a public destination IP address of the second IKE packet according to the correspondence between the first source cookie and the private source IP address of the first IKE packet.

5. The method of claim 1, further comprising:
retrieving target information of the first IKE packet, wherein the target information comprises a first destination IP address and/or a first target cookie;
recording correspondence between target information and the private source IP address of the first IKE packet;
receiving an incoming third IKE packet comprising a source cookie equaling the first source cookie, and/or a third source IP address equaling the first destination IP address.

6. A system for network address port translation, gating a virtual private network, comprising:
a communication unit receiving an outgoing first Internet Key Exchange (IKE) packet and a first incoming Encapsulating Security Payload (ESP) packet, wherein the IKE packet comprises an IP header specifying a private source IP address and a first destination IP address, and the ESP packet comprises a first source IP address and a second destination IP address, wherein the first source IP address equals the first destination IP address;
a storage device storing the private source IP address and the first destination IP address in corresponding fields of a first table;
a processor, connected to the communication unit and the storage device, retrieving the first source IP address of the first ESP packet, searching the first table for a match of the first source IP address, and substituting the searched match for the second destination IP address of the ESP packet.

7. The system of claim 6, wherein the processor further retrieves a first SPI of the first ESP packet, stores the first SPI and the private source IP address in corresponding fields of a second table, receives a second incoming ESP packet, comprising a third destination IP address and a second SPI, wherein the second SPI equals the first SPI, retrieves the second SPI of the second ESP packet, and substitutes the private source IP address for the third destination IP address of the ESP packet according to the first and second tables.

8. The system of claim 7, wherein the storage device further stores the SPI in preset fields for private and public port numbers of a network address port translation table.

9. The system of claim 6, wherein the processor further retrieves the first source cookie of the first IKE packet, stores source IP address of the first IKE packet, receives an incoming second IKE packet comprising a second source cookie equaling the first source cookie, and substitutes the private source IP address for a public destination IP address of the second IKE packet according to the correspondence between the first source cookie and the private source IP address of the first IKE packet.

10. The system of claim 6, wherein the processor further retrieves target information of the first IKE packet, wherein the target information comprises a first destination IP address and/or a target cookie, stores correspondence between target information and the private source IP address of the first IKE packet, receives an incoming third IKE packet comprising a source cookie equaling the first source cookie, and/or a third source IP address equaling the first destination IP address.

11. A computer readable storage medium for storing a computer program providing a method for network address port translation, the method comprising:
receiving an outgoing first Internet Key Exchange (IKE) packet, comprising an IP header specifying a private source IP address and a first destination IP address, wherein the first destination IP address is directed to a node outside the VPN;
recording the private source IP address and the first destination IP address in corresponding fields of a first table;
receiving a first incoming Encapsulating Security Payload (ESP) packet, comprising a first source IP address and a second destination IP address, wherein the first source IP address equals the first destination IP address;
retrieving the first source IP address of the first ESP packet;
searching the first table for a match of the first source IP address; and
substituting the located match for the second destination IP address of the ESP packet.

12. The storage medium of claim 11, wherein the method further comprises:
retrieving a first SPI of the first ESP packet;
recording the first SPI and the private source IP address in corresponding fields of a second table;
receiving a second incoming ESP packet, comprising a third destination IP address and a second SPI, wherein the second SPI equals the first SPI;
retrieving the second SPI of the second ESP packet; and
substituting the private source IP address for the third destination IP address of the ESP packet according to the first and second tables.

13. The storage medium of claim 12, wherein the SPI is stored in preset fields for private and public port numbers of a network address port translation table.

14. The storage medium of claim 11, wherein the method further comprises:
retrieving a first source cookie of the first IKE packet;
recording correspondence between the first source cookie and the private source IP address of the first IKE packet;
receiving an incoming second IKE packet comprising a second source cookie equaling the first source cookie; and
substituting the private source IP address for a public destination IP address of the second IKE packet according to the correspondence between the first source cookie and the private source IP address of the first IKE packet.

15. The storage medium of claim 11, wherein the method further comprises:
retrieving target information of the first IKE packet, wherein the target information comprises a first destination IP address and/or first target cookies;
recording correspondence between target information and the private source IP address of the first IKE packet;
receiving an incoming third IKE packet comprising a source cookie equaling the first source cookie, and/or a third source IP address equaling the first destination IP address.
